(19) United States
(12) Patent Application Publication
(10) Pub. No.: US 2004/0015591 A1
(43) Pub. Date: Jan. 22, 2004

(54) Collective TCP control for improved wireless network performance

(76) Inventor: Frank Xiao-Dong Wang, San Jose, CA (US)

Correspondence Address: STUART T AUVINEN, 429 26TH AVENUE, SANTA CRUZ, CA, 95062-5319, US

(21) Appl. No.: 10/064,481

(22) Filed: Jul. 18, 2002

(51) Int. Cl. G06F 15/16

(52) U.S. Cl. 709/228; 709/230

(57) ABSTRACT

A web-enabled cell phone communicates to Internet servers over a radio link. Multiple connections for web browsing or email are combined into a single persistent connection or pipe over the radio link between a client agent running on the cell phone and a TCP proxy. Combining connections allows for better use of the available bandwidth on the radio link. Wireless acceleration cards on servers gather packet loss statistics that are sent to a collective TCP control (CTC). Losses for connections between a client-server pair are aggregated, and aggregate losses are compared to a threshold. When the aggregate losses are below the threshold, the losses are likely to be sporadic radio-link losses. When the aggregate losses are above the threshold, the losses are likely due to router congestion. TCP parameters can be better adjusted based on whether the losses are radio or router losses.

### BACKGROUND OF INVENTION

This invention relates to wireless Internet, and more particularly to collective wireless Transport-Control-Protocol (TCP) connections.

The Internet has grown rapidly by connecting personal computers (PC's) and servers using wired connections. Telephone modems and more traditional network interfaces such as Ethernet have ultimately relied on wired lines.

More recently cellular or wireless telephones have become widely popular. Radio waves carry the analog or digitized voice signals. Wireless modems that allow a PC to connect to the Internet using a cell phone are also common. Other direct wireless network connections such as bluetooth and wifi (IEEE 802.11b) are used.

The Internet was designed to send data packets over wired connections.

Connection protocols such as Transport-Control-Protocol (TCP) Internet Protocol (IP) were designed to accommodate wired errors such as dropped packets at congested routers. Wireless connections produce other kinds of errors that are not handled as well by TCP/IP.

FIG. 1 shows a radio connection to the Internet. Cell phone 10 could be a cellular phone with an Internet browser or email program running on it, or another portable device with Internet capabilities such as a personal digital assistant (PDA) or palm computer. Cell phone 10 transmits and receives radio-frequency signals from base station 12. Base station 12 can be a cellular base station or other local transmitter. Gateway General Packet Radio Server Support Node GGSN router 14 collects packets received from one or more base stations 12 and forwards these TCP/IP packets.

The TCP/IP packets are sent over Internet 20 through gateway 16. Remote servers 18 can be accessed. Data from remote servers 18 can then be displayed on cell phone 10 as TCP/IP packets are exchanged in a connection to remote servers 18.

Packet loss can occur in Internet 20 as packets are dropped by congested Internet routers or gateways. Dropped packets can be re-requested using the TCP protocol. Congestion control protocols may be activated.

Radio transmission causes unique kinds of errors. As cell phone 10 is moved, perhaps as its user is driving down a freeway, base station 12 eventually becomes farther away than second base station 12′. The radio connection is transferred or handed off from base station 12 to second base station 12′. Some additional delay in reception of packets can occur as cell phone 10 switches base stations. At the new location, cell phone 10′ may even lose its radio connection as radio signals are blocked by mountains, buildings, tunnels, large trucks, or other obstructions.

Additional cell phones 10″ may also connect to second base station 12′, casing delays for cell phone 110′ due to the radio bands being used by other cell phones 10″. A variable latency of packets can occur as a result of the radio link. Packets can also be dropped entirely by the radio link. The latency can be so long that web servers and browsers believe the packets are lost completely, but are simply delivered late due to delayed radio connections. The standard TCP behavior of re-transmitting these delayed packets simply causes more congestion. Other standard TCP congestion-control methods can make the radio-loss problems worse.

FIGS. 2A-E show prior-art web-page connections. Client browser 62 requests a web page from web server 64. A first TCP connection CON1 is established between client browser 62 and server 64. A series of packets are exchanged that use the hyper-text transfer protocol (HTTP). The top-level web page file, TOP.HTML, is requested and sent by the first connection CON1. Client browser 62 then parses the TOP.HTML file for references to graphics or other objects that are stored in separate files. Three such objects are detected: OBJ1, OBJ2, and OBJ3.

Three more connections are established by client browser 62 to server 64 to retrieve these objects. Second connection CON2 retrieves OBJ1, third connection CON3 retrieves OBJ2, and fourth connection CON4 retrieves OBJ3. These objects are then displayed on the web page at positions indicated by the TOP.HTML file.

Many web servers allow up to four concurrent connections. FIGS. 2B-E are time-sequence graphs showing the four connections. Each connection uses only a small fraction of the total available bandwidth for a connection. Once a connection finishes, another connection can begin as long as no more than 4 connections are open concurrently. Also, some connections may take place after other connections.

Bandwidth is often under-utilized because a typical web page has many small objects. Since only 4 small objects can be retrieved at a time, the total available bandwidth is not fully used. For example, when 4 objects of 1 K-byte are fetched by the four concurrent connections, only 4 KB of bandwidth is used, of a total bandwidth of 384 Kbps or more. About 90% of the available bandwidth is not used.

FIGS. 3A-B show prior-art e-mail connections. Email client 72 fetches email messages from email server 74. A separate request is sent for each message. Typically the email messages are requested and sent one after the other.

Email client 72 and mail servers 74 exchange information before retrieving email. First an authentication occurs between client 72 and server 74. Then client 72 requests information about how many new email messages are on mail server 74. The stat command can be used. Server 74 replies with a message list, such as MSG1, MSG2, MSG3. Client 72 then requests MSG1. Mail server 74 sends MSG1. Client 72 and server 74 then repeat the steps for MSG2 and MSG3.

FIG. 3B shows that these email messages are received at separate times. A total of 3 round-trip times (RTT are needed to request and receive the three email messages MSG1, MSG2, MSG3. The available bandwidth remains largely unused during most of the time. Short, bursty connections waste much of the available bandwidth.

What is desired is a modification or enhancement of the TCP protocol that is better tuned for use with wireless networks. Collective control of TCP connections and IP packets is desired for wireless connections.

### BRIEF DESCRIPTION OF DRAWINGS

FIG. 1 shows a radio connection to the Internet.

FIGS. 2A-E show prior-art web-page connections.

FIGS. 3A-B show prior-art e-mail connections.

FIG. 4 is a diagram of the layers of software and hardware in a wireless network with collective TCP control.

FIG. 5 is a diagram of a wireless network with wireless acceleration.

FIGS. 6A-B highlight aggregating wireless TCP connections for a web-page.

FIGS. 7A-B highlight combining email messages into a single wireless connection.

FIG. 8A shows four wireless connections that exceed the available bandwidth.

FIG. 8B shows the CTC limiting packet size to meet the available bandwidth.

FIG. 9 is a diagram of collective-TCP control of wireless connections to mobile clients.

FIG. 10 shows more detail of collective TCP control (CTC) 30.

FIG. 11 is a flowchart of a simple algorithm to determine from the collective TCP connection statistics whether packet loss is due to losses on the radio links or router losses.

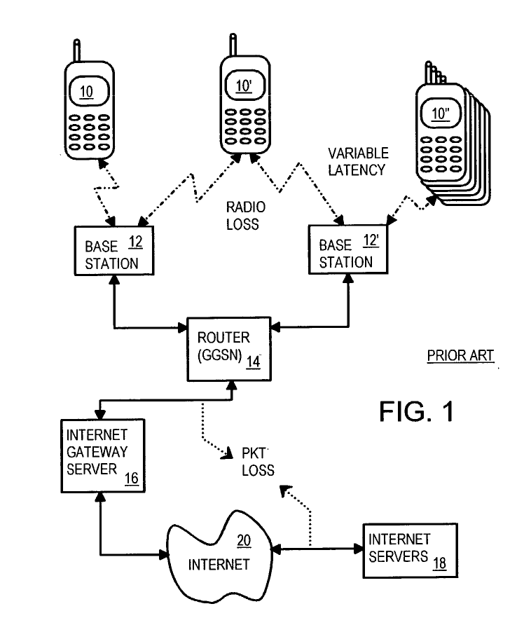

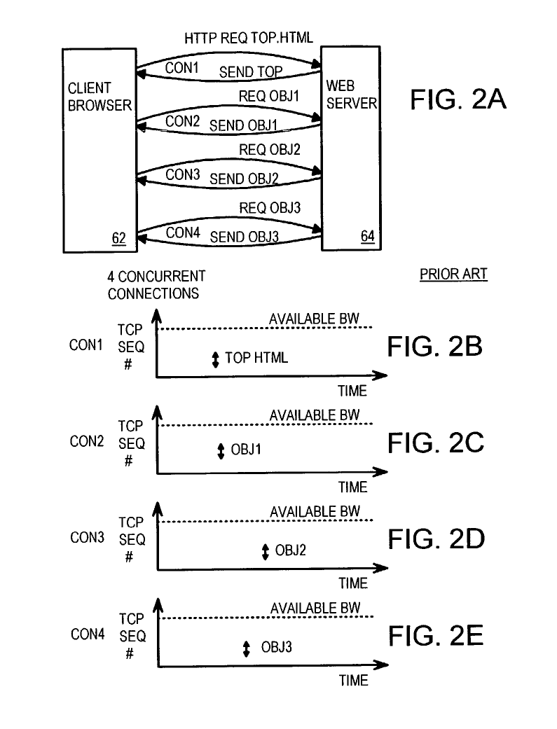

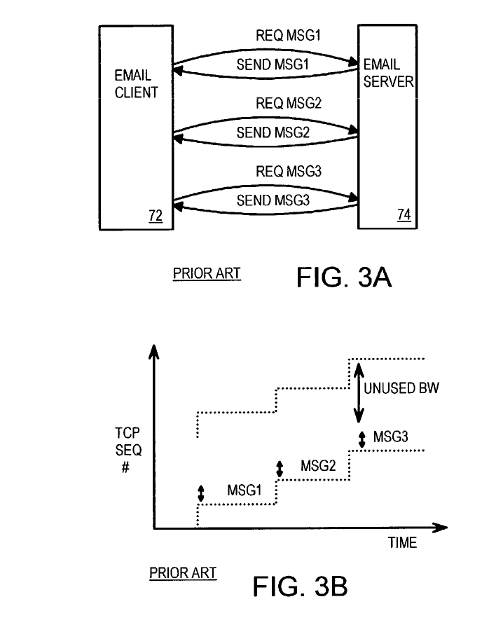

### DETAILED DESCRIPTION

The present invention relates to an improvement in wireless Internet connections.

The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

TCP is well-tuned for wired connections. Packets are usually dropped because of router congestion. Congestion-control methods can be invoked to limit packet flow at congested points, and dropped packets can be re-transmitted. Since packet latency is low, packets can automatically be re-transmitted after a short timeout.

Wireless connections can have much longer latencies. The standard timeout can occur while the packet is still in transit and has not really been dropped re-transmitting such slow packets merely increases congestion of wireless links.

Radio losses can occur erratically. Prediction of network conditions based on a single wireless connection is inaccurate since the radio conditions can quickly change as the receiver moves past radio-wave obstructions.

The inventor has realized that collecting or aggregating the status of many wireless connections allows for better, more accurate prediction of network conditions. Determining the loss type (wireless radio loss or router congestion) can be best made when many connections are considered collectively. Adjustments can then be made for many connections, rather that on a per-connection basis.

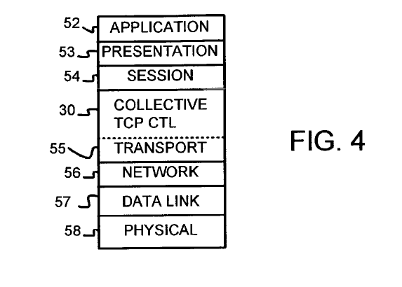

FIG. 4 is a diagram of the layers of software and hardware in a wireless network with collective TCP control. User data is read or displayed by application layer 34, the top layer in the 7-layer Open Systems Interconnection (OSI) model describing network communication. Application layer 52 passes the data down to presentation layer 53, then to session layer 54, transport layer 55, network layer 56 and data link layer 57. Some layers add header information such as source and destination addresses of the transmitting and receiving network stations, and append frame error-check information. Physical layer 58 includes the wireless adapter card and the radio transceiver or other communications media, which carries files, divided into packets with header and frame error-check information added.

The wireless transceiver transmits packets bit-by-bit in a serial fashion from physical layer 58 of the transmitter to physical layer 58 of the receiver. These bits are assembled into frames and passed up from physical layer 58 to data link layer 57, then assembled into packets for network layer 56. Transport layer 55 then checks for errors and strips off headers and frame error-check information. Session layer 54 reassembles the data or files, which are sent to application layer 52 by presentation layer 53.

Transport layer 55 is modified to include collective TCP control (CTC) 30. CTC 30 collects and aggregates status information from several TCP connections rather than from just a single TCP connection. Flow and timeout adjustments can be made based on this aggregate connection status. Better, more accurate network adjustments can be made based on the collective connection data, applied to several connections rather than to individual TCP connections.

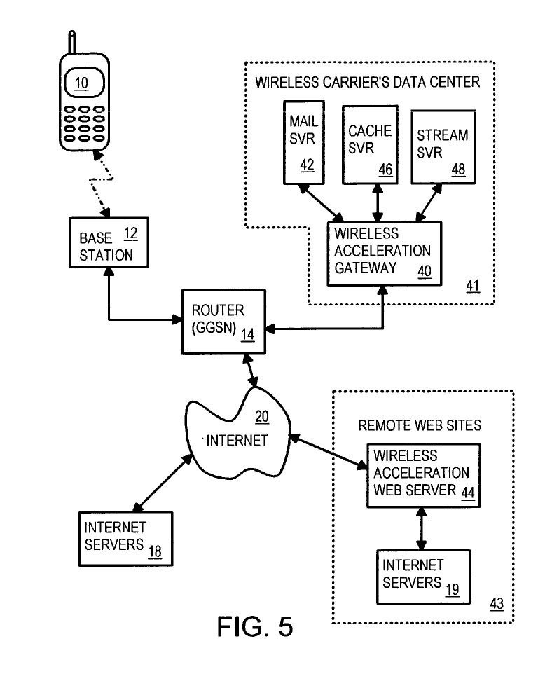

FIG. 5 is a diagram of a wireless network with wireless acceleration. A client browser running on cell phone 10 connects to remove server 18 on Internet 20. Base station 12 has a transceiver that communicates with cell phone 10 using radio-frequency (RF) signals. GGSN router 14 acts as a gateway to Internet 20 for the wireless service provider or carrier.

Wireless carrier data center 41 provides various added services to wireless subscribers. Mail server 42 stores email or digitized voice messages for the user. Cache server 46 contains a cached copy of commonly-used web pages, such as weather, news, traffic, and stock listings. Streaming server 48 provides high-bandwidth data streams, such as video or audio clips.

Wireless acceleration gateway 40 includes a collective TCP control (CTC) module that aggregates connection statistics for several connections to cell phone 10. Connections from mail server 42, cache server 46, or streaming server 48 can be combined into larger persistent connections, and several different connections to cell phone 10 can be adjusted for performance in response to the aggregated connection statistics. Connections from remote server 18 may also be adjusted using the aggregate connection statistics.

Some remote web sites 43 can be enhanced for better wireless performance. Wireless acceleration server 44 is coupled to remote servers 19 to provide better control of TCP connections to cell phone 10. Wireless acceleration server 44 can make adjustments to the window size or packet payload size for all packets from remote server 19 to cell phone 10. These adjustments can be made in response to statistics aggregated by wireless acceleration gateway 40.

Since many connections can exist between cell phone 10 and remote server 19, such as 4 concurrent HTTP connections for a web page, all such connections for a client-server pair can be aggregated and adjusted together. Alternatively, all connections form cell phone 10 that pass through GGSN router 14 can be statistically aggregated and adjusted together, even though different remote servers 18, 19 are accessed.

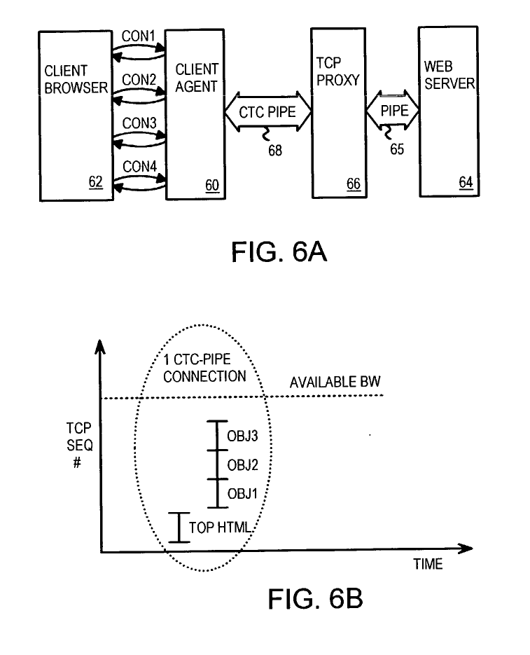

FIGS. 6A-B highlight aggregating wireless TCP connections for a web-page. Client browser 62 on a cell phone retrieves a top-level web-page file TOP.HTML and three objects OBJ1, OBJ2, OBJ3 from web server 64. Client browser 62 makes four connections CON1, CON2, CON3, CON4 to client agent 60, which also is running on the cell phone.

Client agent 60 combines these four concurrent connections into a single connection on collective-TCP-control CTC-pipe 68. This single connection is transmitted over the radio link to the base station and GGSN gateway. TCP proxy 66 receives the packets sent over CTC-pipe 68 from client agent 60, and forwards these packets as a single TCP connection over wired pipe 65 to web server 64. Alternately, TCP proxy 66 could generate separate connections to web server 64. TCP proxy 66 can be running on a separate hardware box attached to wireless acceleration gateway 40 or wireless acceleration server 44, or can be integrated with these or other units. TCP proxy 66 can parse the TOP.HTML web-page file to determine what objects need to be fetched. These objects can then be pre-fetched by TCP proxy 66 and sent to client agent 60 before client browser 62 requests each object.

FIG. 6B shows that the CTC pipe combines separate TCP connections for transmission over the radio link. The first connection for the top HTML file is sent as a first request in the CTC pipe connection. Then once the top page is parsed, additional packets in the single connection are sent as requests for objects OBJ1, OBJ2, OBJ3. All four requests can be sent in the same single combined connection. A persistent connection is made over CTC-pipe 68 between client agent 60 and TCP proxy 66, while several more temporary connections are made and ended to web server 64 and client browser 62.

The available bandwidth is better utilized when the separate connections are aggregated into the single CTC-pipe connection. The requests can be sent in successive packets with increasing TCP sequence numbers. The requests can be sent immediately without waiting for receipt of the previous request's object. This combining of requests into a single connection increases throughput.

For example, a web page TOP.html has 12 objects of 1 K size. Normally, the 12 objects are sent in groups of 4 over the 4 concurrent connections, thus requiring 3 RTT to retrieve them all. Using CTC-pipe 68, all 12 objects can be retrieved in a single connection, using 12 KB of bandwidth. Thus all objects can be retrieved in one 1 RTT.

That's a saving of 200%. Also, in terms of interactive delay, if a RTT is 10 seconds, then user would have to wait for slightly more than 10 seconds rather than 3×10=30 seconds.

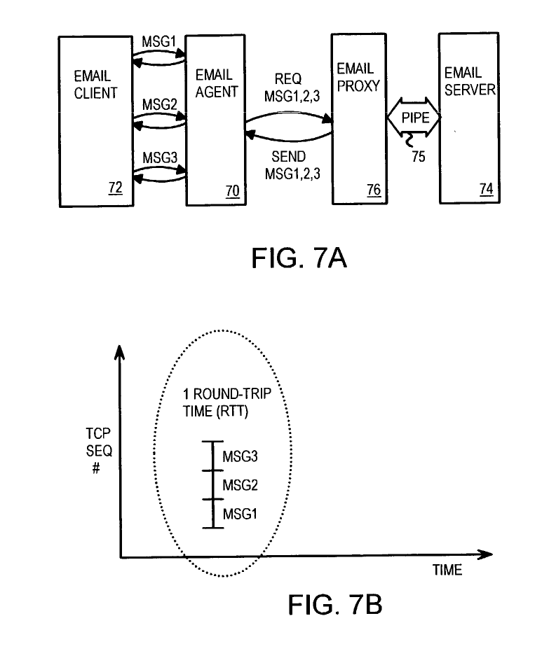

FIGS. 7A-B highlight combining email messages into a single wireless connection. Email client 72 running on a cell phone requests messages 1, 2, 3 from mail server 74.

Email agent 70 receives the 3 message requests from email client 72 and combines them into a single request for all messages. This single request is transmitted over the radio link to email proxy 76 which is running on wireless acceleration gateway 40 or wireless acceleration server 44 for remote email. Email proxy 76 connects to mail server 74 using mail pipe 75, which is a single connection. An email standard such as post-office-protocol 3 (POP3) can be used rather than TCP for email messages.

FIG. 7B is a time-sequence diagram showing aggregation of email message requests on the radio link. Email agent 70 combines requests from email client 72 for three messages MSG1, MSG2, MSG3. The requests for these messages are sent as packets in a single mail connection. Rather than having to wait for receipt of the previous message before a next message request is sent, all requests can be sent at about the same time. Thus all messages can be received in about one RTT rather than 3 RTT's.

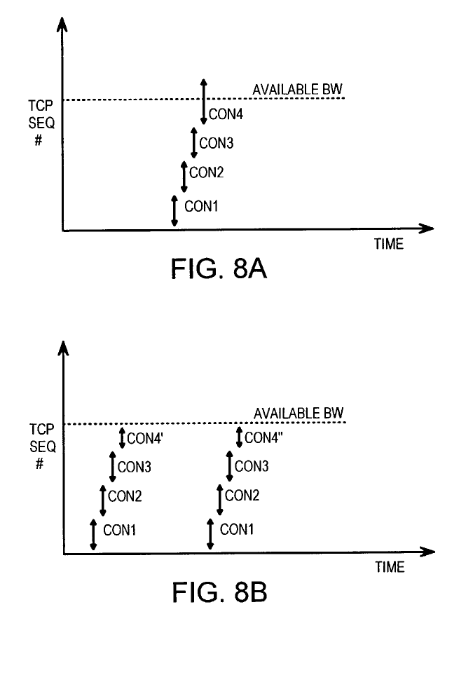

FIG. 8A shows four wireless connections that exceed the available bandwidth.

When connections are combined into a single connection in the CTC pipe, the available bandwidth can be exceeded at a point in time. Connections CON1, CON2, CON3, CON4 occur at about the same time (concurrently) and the data transferred by their packets exceeds the available wireless bandwidth to the cell phone.

When the total data sent for the packets for the four connections exceeds the buffer size in the GGSN router or base station, and overflow occurs. The packets for CON4 can also remain in the buffer for a long time, waiting for the quality of the radio link to improve, or being delayed by congestion from other cell phones using the same base station. A packet timeout can then occur, and the packet can be dropped.

FIG. 8B shows the CTC limiting packet size to meet the available bandwidth. The first three connections, CON1, CON2, CON3 are below the bandwidth limit and all of their packets are sent. However, with CON4 the bandwidth limit is exceeded. The CTC detects that the bandwidth limit has been reached by the four connections, and only sends some of the packets for CON4 so that the bandwidth limit is not exceeded.

Some time later (1 RTT later) reply packets from the server are received, and the buffer empties. Additional packets for the four connections can be sent. The unsent packets for CON4 are now sent. A flow flag can be set by the CTC to delay additional packets from the last connection CON4.

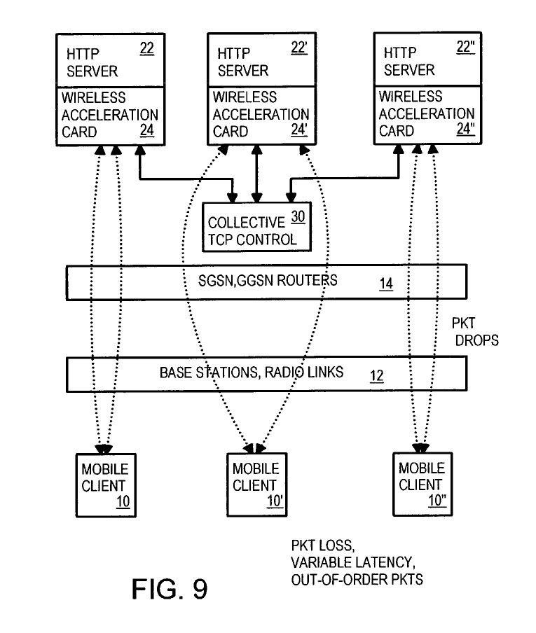

FIG. 9 is a diagram of collective-TCP control of wireless connections to mobile clients. Mobile clients on cell phone 10 connect to web server 22 using the HTTP high-level protocol sent through IP packets using TCP connections. Several connection are made between cell phone 10 and web server 22. Likewise, mobile clients running on cell phone 10′ connect to web server 22′, and other mobile clients running on cell phone 10″ connect to web server 22″.

These connections include a radio link to base station 12, and a wired link from base station 12 to GGSN router 14, and over the Internet to web servers 22, 22′, or 22″.

Wireless acceleration card 24 can be located near web server 22 or at the wireless carrier's data network near GGSN router 14. Wireless acceleration card 24, 24′, 24″ intercept TCP packets for connections to cell phones 10, 10′, 10″ and aggregate connection statistics and control. Wireless acceleration card 24 is a hardware accelerator for wireless TCP connections using wireless acceleration gateway 40. Specifically, wireless acceleration card 24 offloads some TCP tasks, like checksum, and TTL calculations to specialized hardware.

Wireless acceleration cards 24, 24′, 24″ communicate with collective TCP control 30, which stores connection statistics. Connection control information is sent from collective TCP control 30 to wireless acceleration cards 24, 24′, 24″ to adjust connection parameters such as window size and timeouts. Connection statistics are collected by collective TCP control 30 about packet loss, latency, and out-of-order packet reception.

A TCP Control block contains all TCP information used by servers. In a modified TCP Control block, packet-in-flight, RTT calculation, timeout values, window size, retransmitted packet count, concurrent connections, bandwidth estimation. These TCP parameters are changed by passing messages between software processes, with the messages including these parameters.

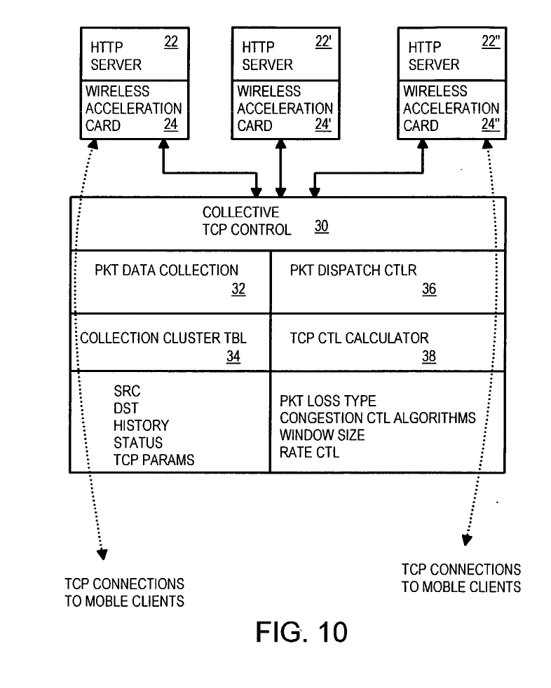

FIG. 10 shows more detail of collective TCP control (CTC) 30. Web servers 22, 22′, 22″ have several TCP connections to mobile clients on cell phones. Wireless acceleration cards 24, 24′, 24″ collect connection statistics that are reported to CTC 30.

Packet data collector 32 receives the connection status reports from wireless acceleration cards 24. The endpoints of the connection are compared to connection clusters in connection cluster table 34. For example, all connections from any server to one cell phone could be one cluster or aggregation of connections, or only connections from one server to one cell phone could be included in one cluster. The source and destination IP addresses and TCP port, or other identifiers are stored in table 34, along with history of the connections, connection status, and current TCP parameters. This information can be obtained from the TCP and IP headers of the packets.

The TCP parameters or statistics include:

Concurrent TCP connections: how many TCP connections are opened at the same time. For example, with HTTP traffic, this is commonly at 4 connections.

Number of Retransmitted Packets.

Estimated bandwidth: this can be different from the nominal bandwidth in the table. It is a link's real capacity to handle traffic, which is often affected by its network design (e.g., long or short latency, buffer size at base station, router, etc.), and radio link situation (low loss, high loss, etc.). For example, a radio link with high loss, and long latency will have reduced bandwidth than its nominal bandwidth.

Packet-in-flight: measures how many packets are sent out but not yet received.

This statistic is useful for deciding whether to send more packets or not. It can be compared with the estimated bandwidth.

TCP control calculator 38 reads the statistics stored in cluster table 34 for a client-server pair of cluster, and calculates the type of packet loss—either radio loss or router loss. A different connection control algorithm or procedure can be applied for the connections in the cluster, depending on the type of packet loss determined by TCP control calculator 38.

The TCP window size and rate control for the connections can be adjusted by TCP control calculator 38 and stored in the table. Rate control is also called pacing. All of the packets in a window are not sent simultaneously. Instead, the packets are sent out in a burst, then after a quite period, another burst. Bursts are harder for networks to handle than smoothed-out traffic. Some packets are sent, then a delay in transmission or a pre-calculated time before more packets are sent. This results in smoother traffic.

Once these parameters are determined, packet dispatch controller 36 sends these parameters to wireless acceleration card 24, 24′, 24″ to adjust TCP packets being sent by wireless acceleration cards 24, 24′, 24″.

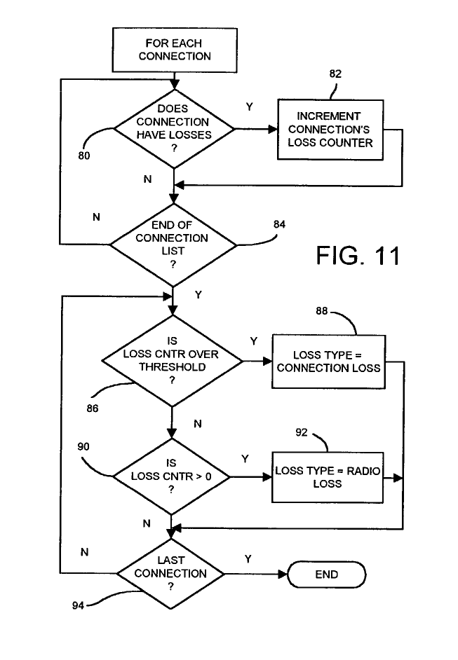

FIG. 11 is a flowchart of a simple algorithm to determine from the collective TCP connection statistics whether packet loss is due to losses on the radio links or router losses. More complex algorithms using heuristics or other methods could be substituted.

Packet losses are counted for a period of time for all connections in a cluster, such as all connections between any client programs running on a cell phone, and a remote server. When the number of lost packets is below a threshold number, it is assumed that the losses are caused by the radio link. When more packet losses occur, it is assumed to be caused by congestion at a router.

The inventor has realized that there are different natures of losses caused by congestion and radio-link data corruption. Radio-link errors tend to be random errors, corrupting 1 or 2 packets from time to time. Radio-link errors tend to be randomly distributed on different connections. A packet loss can happen on one radio connection, but not necessarily on all radio connections. On the other hand, congestion losses tend to drop many packets for all connections.

For example, during one RTT, when the number of connections having packet losses are greater than 50%, then it's likely due to congestion loss. The percentage of connections having radio losses are typically less than 30%. This example is based on experience and may vary with networks and conditions.

For each connection in a list of connections in a cluster of client-server pairs, collective TCP control CTC 30 reads the connection's entry in the cluster table to see if any packet losses were recorded. If any losses are found in the connection's entry, step 80, the cluster's loss counter is advanced by the number of lost packets, step 82. The packet loss flag in the connection's entry is cleared or reset when no losses have occurred. When a packet loss occurs in the future, this packet loss flag is again set.

Steps 80, 82 are repeated for other connections in the cluster, and for other clusters of connections. When all clusters of connections have been checked for losses, step 84, then the loss counters can be examined. For each cluster of connections, the cluster's loss counter is read and compared to a pre-determined threshold, step 86. If the loss counter is above the threshold, step 88, then the loss type field in the cluster's table entry is set to connection loss or router loss. When many packets are lost, it is more likely that the losses are caused by a congested router that is dropping many or all packets received.

When the loss counter is below the threshold, but more than zero, step 90, then the loss type is set to radio loss for the cluster of connections to the client phone, step 92. When smaller numbers of packets are lost, radio interference is often the cause. Radio interference can cause sporadic dropped packets over the radio link.

When the loss connection counter is still zero, step 90, then no losses are occurring. The loss connection counter is the number of connections having packet losses. When no loss occurs, the loss type is set to noLossType, and no adjustment in TCP parameters is needed.

TCP parameters can be adjusted based on the loss type. For the congestion loss type, TCP parameters are sent to the normal timeout, back-off, retransmission, etc. For the radio loss type, wireless TCP algorithms are enabled, which may as explained previously, it may have different timeout, back-off value, and different retransmission strategy, and some new techniques.

Steps 86-92 are repeated for other clusters. Once loss counters for all clusters have been processed, step 94, a TCP-parameter adjusting routine can be executed, or execution halted. The routine can be started periodically, such as when initiated by a timer, or can run continuously or in response to an interrupt.

Alternate Embodiments

Several other embodiments are contemplated by the inventor. For example, various modules and components may be implements in software, firmware, or hardware. Modules may be partitioned in a variety of ways.

The threshold value can be adjusted over time based on experience, and may even be a function of various conditions, such as time of day, day of the week, sunspot activity, or other causes of increased radio interference. For example, at night AM radio stations reduce transmission power, reducing interference.

The wireless acceleration card can plug into a Peripheral Component Interconnect (PCI) or other adapter-card slot on a web server, and can replaced an Ethernet card in some embodiments. The invention can be used with ordinary remote web sites, or with web sites that are cached at the wireless carrier's data center, or at a third-party web hosting center or back-up location.

The invention has been described as running client programs or modules on a cell phone. Internet-enabled cell phones are one embodiment of such as cell phone, but other web-enabled mobile devices can be substituted in various embodiments of the invention. For example, the cell phone could be a cellular phone with an Internet browser or email program running on it, or another portable device with Internet capabilities such as a personal digital assistant (PDA) or palm computer or laptop computer with a wireless connection. The wireless network could be a cellular network with many base stations over a metropolitan or regional area, or could be localized to a campus or building.

The invention may combine connections together for transmission over the radio link using an agent and proxy. A combined pipe may be used for email messages but not for web pages, or for web pages and not email, or for both. More than one CTC pipe or persistent connection can be used, and the available bandwidth divided among the connections or pipes.

Each TCP connection includes several packets that are exchanged. For a web-browser connection using the HTTP protocol, a SYN packet is sent to the server, an ACK packet is sent back to the client, a SYN+ACK packet is returned to the server, and a FIN packet closes the connection. Other packets can be used to transfer data, or the FIN packet can include the data.

The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. 37 C.F.R. §1.72(b). Any advantages and benefits described may not apply to all embodiments of the invention. When the word ‘means’ is recited in a claim element, Applicant intends for the claim element to fall under 35 USC §112, paragraph 6. Often a label of one or more words precedes the word ‘means’. The word or words preceding the word ‘means’ is a label intended to ease referencing of claims elements and is not intended to convey a structural limitation. Such means-plus-function claims are intended to cover not only the structures described herein for performing the function and their structural equivalents, but also equivalent structures. For example, although a nail and a screw have different structures, they are equivalent structures since they both perform the function of fastening. Claims that do not use the word means are not intended to fall under 35 USC §112, paragraph 6. Signals are typically electronic signals, but may be optical signals such as can be carried over a fiber optic line.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1. A wireless Internet accelerator comprising:
a client program running on a mobile device;
a client agent running on the mobile device, the client agent coupled to the client program by multiple concurrent Transport-Control-Protocol (TCP) connections;
a server proxy not on the mobile device, coupled to the client agent on the mobile device by a radio link, and coupled to Internet servers by an Internet connection; and
a collective TCP pipeline, using the radio link to exchange packets between the client agent and the server proxy, for exchanging packets from the multiple concurrent TCP connections from the client program using a collective connection that is a single TCP connection between the client agent and the server proxy,
whereby multiple concurrent TCP connections from the client program are combined by the client agent for transmission over the radio link using the collective connection.

2. The wireless Internet accelerator of claim 1 further comprising:
a collective TCP controller, receiving packet loss statistics from a plurality of server proxies, for generating TCP parameters that are sent to the plurality of server proxies to adjust TCP parameters for the collective TCP pipeline,
whereby packet loss statistics for many connections are collected and TCP parameters set for radio links.

3. The wireless Internet accelerator of claim 2 wherein the collective TCP controller aggregates the packet loss statistics for several connections to different Internet servers by the mobile device;
the collective TCP controller adjusting the TCP parameters based on aggregate packet loss statistics for connections by the mobile device to different Internet servers,
whereby TCP parameters are set based on collective packet loss statistics.

4. The wireless Internet accelerator of claim 3 wherein the collective TCP controller further comprises:
a threshold comparator, for comparing a threshold to an aggregate packet loss collected from the several connections to different Internet servers by the mobile device; and
a parameter calculator, coupled to the threshold comparator, for adjusting the TCP parameters to reduce congestion losses at an Internet router when the aggregate packet loss exceeds the threshold, but for adjusting the TCP parameters to reduce radio losses on the radio link when the aggregate packet loss is below the threshold,
whereby the TCP parameters are adjusted to compensate for radio losses when the aggregate packet loss is below the threshold, but to compensate for router congestion losses when the aggregate packet loss is above the threshold.

5. The wireless Internet accelerator of claim 1 wherein the collective connection over the radio link is a persistent connection that persists for a longer period of time than each of the multiple concurrent TCP connections.

6. The wireless Internet accelerator of claim 5 wherein the client program is a web browser and the multiple concurrent TCP connections comprise four TCP connections that are open concurrently.

7. The wireless Internet accelerator of claim 1 further comprising:
an email client running on the mobile device;
an email agent, the email agent coupled to the email client by multiple sequential requests for email messages;
an email proxy not on the mobile device, coupled to the email agent on the mobile device by the radio link, and coupled to email servers by an Internet connection; and
a collective email pipeline, using the radio link to exchange email messages between the email agent and the email proxy, for exchanging email messages from the multiple sequential requests from the email client using a collective email connection that transfers multiple email messages in parallel between the email agent and the email proxy,
whereby email messages are combined for transmission over the radio link.

8. The wireless Internet accelerator of claim 7 wherein multiple email messages are transmitted from the email proxy to the email agent over the radio link during a single round-trip-time.

9. The wireless Internet accelerator of claim 1 wherein the mobile device is a web-enabled cell phone or a personal digital assistant (PDA) or a mobile Internet device.

10. A collective connection controller comprising:
a plurality of wireless accelerator means, each coupled to a server, for sending and receiving packets from a mobile device connected over a wireless link;
packet-data collector means for receiving packet statistics from the plurality of accelerator means;
table means for storing the packet statistics from the packet-data collector means;
network settings calculation means, coupled to read the packet statistics from the table means, for determining a wireless-loss condition when network conditions are adversely affected by packet losses over the wireless link, and for determining a congestion-loss condition when network conditions are adversely affected by packet losses due to congestion at an intermediate router, and for adjusting network conditions to compensate for the packet losses; and
network setting means, responsive to the network settings calculation means, for sending network settings adjusted by the network settings calculation means based on the congestion-loss or wireless-loss condition, the network setting means sending the network settings to the plurality of wireless accelerator means,
whereby network settings are adjusted based on packet statistics collected and are adjusted based on a determination of the congestion-loss or wireless-loss condition.

11. The collective connection controller of claim 10 wherein the packet statistics from the plurality of accelerator means include a packet loss indicator for a connection;
wherein the table means stores a counter for connections with lost packets for each client-server pair.

12. The collective connection controller of claim 11 wherein the table means stores a source address, a destination address, and a packet loss indicator for each cluster of connections between a client and a server.

13. The collective connection controller of claim 12 wherein each wireless accelerator means comprises a wireless acceleration card coupled to a server at a remote web site, or coupled to a server or gateway at a wireless carrier data center.

14. The collective connection controller of claim 11 wherein each wireless accelerator means comprises server proxy means for sending packets from a server over the wireless link to a client agent on the mobile device;
wherein the client agent includes connection combining means for combining several connections from a client program on the mobile device into a single connection between the client agent and the server proxy means;
whereby connections are combined for transmission over the wireless link.

15. The collective connection controller of claim 14 further comprising:
base station means, coupled between the mobile device and the plurality of wireless accelerator means, for receiving packets from the wireless link from the mobile device and for transmitting packets over a wired network to one of the plurality of wireless accelerator means.

16. The collective connection controller of claim 14 wherein the several connections from the client program comprise Transport-Control-Protocol (TCP) connections and wherein the network settings include TCP parameters.

17. A method for adjusting network settings comprising:
collecting packet loss counts from a plurality of wireless accelerators;
updating connection records in a table using the packet loss counts collected;
scanning the table for connection records for connections in a cluster of connections to a mobile device;
counting a number of connections in the cluster of connections with packet losses to get an aggregate loss count;
comparing the aggregate loss count for the cluster to a threshold value;
when the aggregate loss count meets the threshold value, signaling a congestion cause for the packet losses;
when the aggregate loss count are below the threshold value but more than zero, signaling a radio cause for the packet losses;
adjusting network settings for connections in the cluster to radio-optimized settings when the radio cause is signaled; and
adjusting network settings for connections in the cluster to congestion-optimized settings when the congestion cause is signaled,
whereby packet loss information is collected from wireless accelerators and used to adjust network settings for connections in a cluster.

18. The method of claim 17 wherein adjusting the network settings comprises adjusting a window size and a time-out when the congestion cause is signaled, but resetting the window size and the time-out to standard values when the radio cause is signaled.

19. The method of claim 18 wherein adjusting the network settings comprises sending Transport-Control-Protocol (TCP) parameters to the plurality of wireless accelerators.

20. The method of claim 17 wherein collecting packet loss counts further comprises collecting endpoint identifiers that include an identifier for the mobile device;
wherein updating connection records comprises searching the table for or storing the endpoint identifiers in the connection record.
